(19) United States
(12) Patent Application Publication
(10) Pub. No.: US 2013/0196216 A1
(43) Pub. Date: Aug. 1, 2013

(54) HIGH-TEMPERATURE-PROOF LITHIUM BATTERY TERMINAL COVER SET

(71) Applicant: HONG-WEN HWANG, HSINCHU CITY (TW)

(72) Inventor: HONG-WEN HWANG, HSINCHU CITY (TW)

(21) Appl. No.: 13/362,020

(22) Filed: Jan. 31, 2012

(51) Int. Cl. H01M 2/04

(52) U.S. Cl. 429/179

(57) ABSTRACT

A high-temperature-proof lithium battery terminal cover set, disposed on a lithium battery, comprising: a sealing plate, disposed on the housing, and is provided with a plurality of through holes, to penetrate at least two terminal sets, that is includes a positive terminal set and a negative terminal set, disposed respectively in through holes. Each terminal set includes: a terminal, on which is provided with a lock-and-fix portion, protruding out sealing plate; a spring, made of insulator, and is sleeved around lock-and-fix portion; a conductive plate, sleeved around lock-and-fix portion, and is connected to battery cells of lithium battery; and a low melting point locking piece, to lock and fix spring and conductive plate onto terminal. The lithium battery terminal cover set, current flowing to terminal can be cut off automatically, preventing fire or explosion.

### BACKGROUND OF THE INVENTION

1. Field of the Invention

The present invention relates to a battery terminal cover set, and in particular to a high-temperature-proof lithium battery terminal cover set realized through temperature control.

2. The Prior Arts

In general, fuse is an electrical element placed in a circuit to protect the circuit, such that when the current in a circuit is overly large, the metal wire or sheet-shaped fuse is melted due to the high temperature incurred, thus leading to open circuit, to protect the circuit from being damaged.

Refer to FIG. 1 for a schematic diagram of a Lithium Battery of the prior art. As shown in FIG. 1, the lithium battery 50 includes battery cells 52, positive and negative terminals 54 and 56, through holes 62, a sealing plate 60, and a housing 58. Wherein, the positive and negative terminals 54 and 56 are connected to the battery cells 52; the housing 58 is used to receive the battery cells; a sealing plate 60 is used to seal the top of the housing 58; and at least two holes 62 are provided on the sealing plate 60, so the positive and negative terminals 54 and 56 can be fixed on the through holes 62 of the sealing plate 60, and leading out of the through holes 62. However, in the structure mentioned above, fuse is not provided in the lithium battery 50, such that when the current is overly large, the connection to the battery cells can not be cut off in time, hereby resulting in catching fire or explosion of the battery.

Therefore, presently, the design and performance of the lithium battery is not satisfactory, and it has much room for improvements.

### SUMMARY OF THE INVENTION

In view of the problems and drawbacks of the prior art, the present invention provides a high-temperature-proof lithium battery terminal cover set to overcome effectively the shortcomings of the prior art.

A major objective of the present invention is to provide a high-temperature-proof lithium battery terminal cover set, that is capable of cutting off automatically positive electrode current or negative electrode current when the current is overly large, thus the ensuing temperature is overly high, without the need of external control, hereby preventing the battery from catching fire or explosion, and enhancing safe utilization of lithium battery.

Another objective of the present invention is to provide a high-temperature-proof lithium battery terminal cover set, that is simple in construction, easy to assemble, having low production cost, and high production efficiency.

In order to achieve the above-mentioned objective, the present invention provide a high-temperature-proof lithium battery terminal cover set, disposed on a housing of a lithium battery, comprising: a sealing plate, and at least two terminal sets. The sealing plate is disposed on the housing, and is provided with a plurality of through holes thereon, for the passing through of the at least two terminal sets. The two terminal sets include a positive terminal set and a negative terminal set, disposed respectively in said through holes. Each terminal set includes: a terminal, on which is provided with a lock-and-fix portion, protruding out said sealing plate; a spring, made of insulator, and is sleeved around said lock-and-fix portion; a conductive plate, sleeved around said lock-and-fix portion, to fix said spring, and is connected to battery cells of the lithium battery; and a low melting point locking piece, locked and fixed onto the lock-and-fix portion, to lock and fix the spring and the conductive plate onto the terminal.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of a lithium battery of the prior art;

FIG. 2 is a cross section of a high-temperature-proof lithium battery terminal cover set according to an embodiment the present invention;

FIG. 3 is an exploded view of a high-temperature-proof lithium battery terminal cover set according to an embodiment of the present invention;

FIG. 4 is a cross section side view of a high-temperature-proof lithium battery terminal cover set according to an embodiment of the present invention; and

FIG. 5 is a cross section side view of a high-temperature-proof lithium battery terminal cover set according to another embodiment of the present invention.

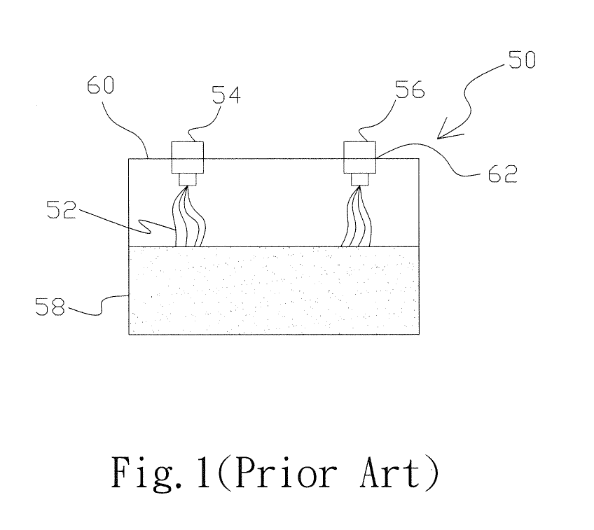

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

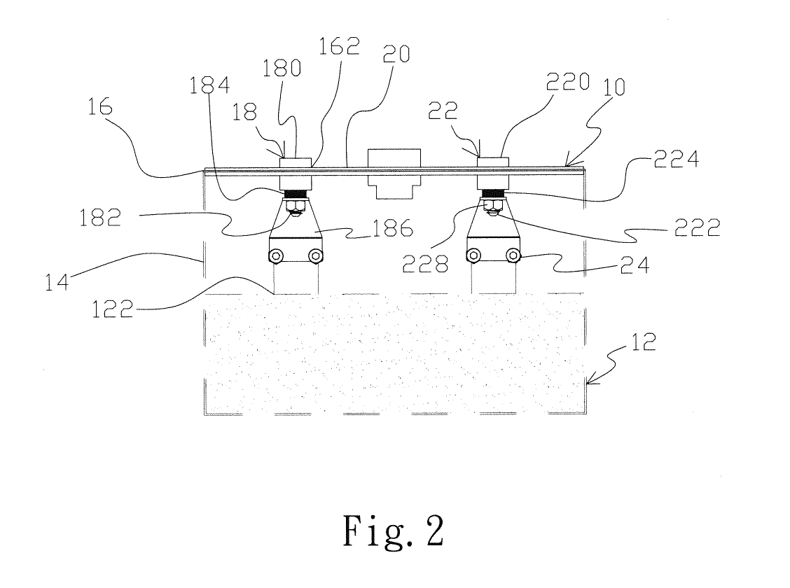

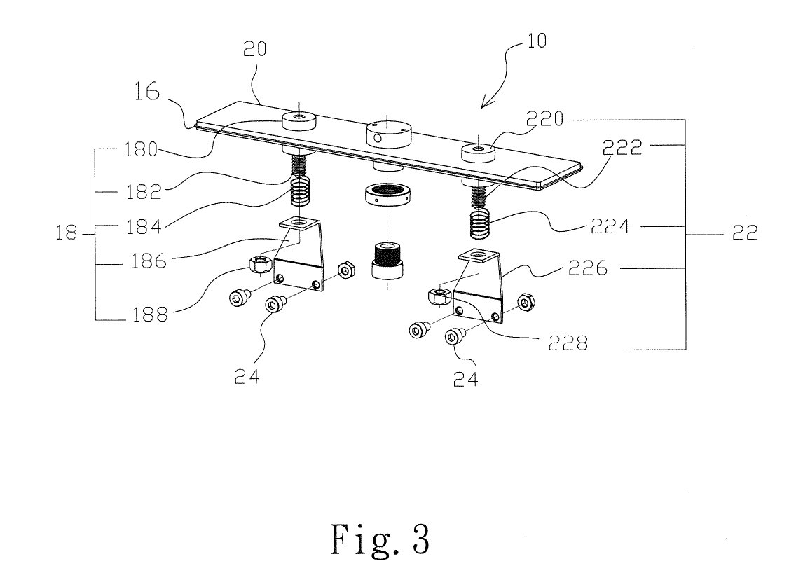

Refer to FIG. 2 for a cross section of a high-temperature-proof lithium battery terminal cover set according to an embodiment the present invention, and FIG. 3 for an exploded view of a high-temperature-proof lithium battery terminal cover set according to an embodiment of the present invention respectively. As shown in FIGS. 2 and 3, the high-temperature-proof lithium battery terminal cover set 10 is disposed on a housing 14 of a lithium battery 12, comprising: a sealing plate 16, and at least two terminal sets. Wherein, the sealing plate 16 is made of metal, which can be disposed on one end of the housing 14 by means of laser welding or ultra-sonic welding, and a plurality of through holes 162 are disposed on the sealing plate 16, for the passing through of at least two terminal sets. The two terminal sets include a positive terminal set 18 and a negative terminal set 22. The positive terminal set 18 includes at least a positive terminal 180, while the negative terminal set 22 includes at least a negative terminal 220. Lock-and-fix portions 182 and 222 are disposed respectively on the positive terminal 180 and negative terminal 182, for the passing of the terminals through the sealing plate 16. In the present embodiment, an insulation film 20 is used to fix the positive terminal 180 and negative terminal 220 onto the sealing plate 16, however, the locking pieces can also be used to lock and fix the positive terminal 180 and negative terminal 220 onto the sealing plate 16. Then, two springs 184 and 224 are sleeved around a lock-and-fix portion 182 of the positive terminal 180, and a lock-and-fix portion 222 of the negative terminal 220. Wherein, the springs 184 and 224 made of insulator, and two conductive plates 186 and 226 made of metal, are sleeved around the lock-and-fix portion 182 of the positive terminal 180, and the lock-and-fix portion 222 of the negative terminal 220, to fix the springs 184 and 224, and connect to the battery cells 122 of the lithium battery 12. In the present embodiment, a the conductive plate 186 utilizes a locking piece 24 to lock and fix the battery cells 122 onto the conductive plates 186 and 226, however, welding and other means can be used to lock and fix the battery cells 122 onto the conductive plates 186 and 226. Finally, two low melting point locking pieces 188 and 228 are locked and fixed onto the lock-and-fix portions 182 and 222, to lock and fix the springs 184 and 224 and conductive plates 186 and 226 onto the lock-and-fix portions 182 and 222 of the positive terminal 180 and the negative terminal 220.

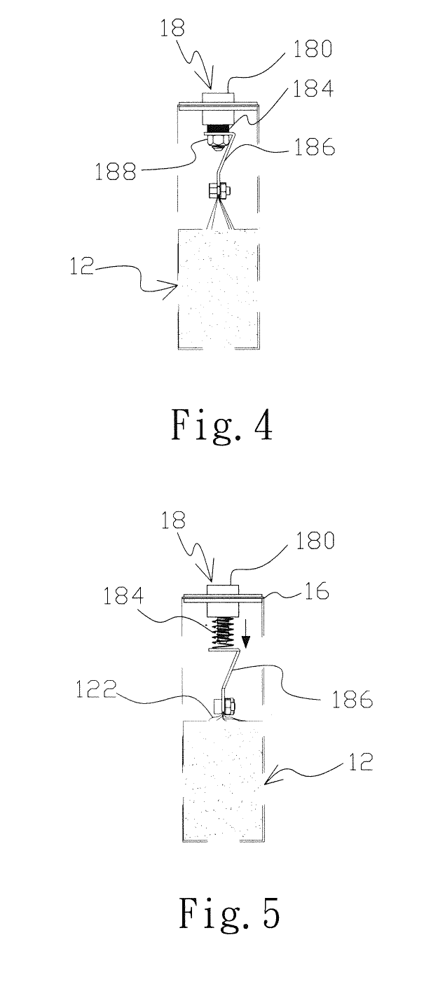

Next, refer to FIG. 4 for cross section side view of a high-temperature-proof lithium battery terminal cover set according to an embodiment of the present invention. In the present invention, the structures of the positive and negative terminal sets 18 and 22 are the same, so only the positive terminal set 18 is taken as example for explanation. As shown in FIG. 4, when the amount of current flowing in the lithium battery 12 is in normal range, it would not incur abnormal temperature increase to reach the melting point of the low melting point locking piece 188. Due to the existence of the low melting point locking piece 188, it can lock and fix the spring 184 and the conductive plate 186. However, since the low melting point locking pieces 188 is made of Al, In, Bi, Pb, or Cd, or alloy thereof, or other materials having melting point lower than that of the positive terminal 180 and conductive plate 186, so as shown in FIG. 5, when the current flowing through is overly high, the positive terminal set 18 will incur high temperature. When the temperature reaches melting point of the low melting point locking pieces 188, it would melt due to the high temperature. Therefore, the spring 184 and conductive plate 186 can no longer be locked and fixed onto the positive terminal 180, and through the restoring force of the spring 184, the conductive plate 186 is released. Since the spring 184 is made of insulator, it can separate the conductive plate 186 and the positive terminal 180, so the current in the battery cell 122 of the lithium battery 12 can not flow to the positive terminal 180 through the conductive plate 186, thus forming an open circuit. As such, the present invention can achieve the same purpose of a fuse, so that current can not flow to the positive terminal, hereby preventing the lithium battery 12 from explosion, and raising safety of utilization.

Summing up the above, the high-temperature-proof lithium battery terminal cover set of the present invention is used in a lithium battery, to control effectively the amount of current flowing in the lithium battery. Through the low melting point locking piece, the temperature control function can be achieved. In the conventional lithium battery, when the current flowing in the lithium battery is overly large, it would incur high temperature in the positive and negative terminals to cause fire or explosion. In this respect, the present invention utilizes the temperature control of the low melting point lock piece, to cut off automatically the current flowing to the positive terminal or the negative terminal, thus preventing fire or explosion due to overly large current and ensuing overly high temperature without the need of external control. Through the application of the present invention, 100 per cent safe utilization of lithium battery can be assured. In addition, the present invention has the advantage of simple construction, low cost, and fast and easy assembly.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A high-temperature-proof lithium battery terminal cover set, disposed on a housing of a lithium battery, comprising:
a sealing plate, disposed on one end of said housing, said sealing plate is provided with a plurality of through holes; and
at least two terminal sets, including a positive terminal set and a negative terminal set, disposed respectively in said through holes, each terminal set includes:
a terminal, on which is provided with a lock-and-fix portion, protruding out said sealing plate;
a spring, made of insulator, and is sleeved around said lock-and-fix portion;
a conductive plate, sleeved around said lock-and-fix portion, to fix said spring, to connect to battery cells of said lithium battery; and
a low melting point locking piece, locked and fixed to said lock-and-fix portion, to lock and fix said spring and said conductive plate onto said terminal.

2. The high-temperature-proof lithium battery terminal cover set as claimed in claim 1, wherein said low melting point locking piece is made of Al, In, Bi, Pb, or Cd, or alloy thereof.

3. The high-temperature-proof lithium battery terminal cover set as claimed in claim 1, wherein said battery cell is locked and fixed onto said conductive plate through utilizing a locking piece.

4. The high-temperature-proof lithium battery terminal cover set as claimed in claim 1, wherein said sealing plate is made of metal.

5. The high-temperature-proof lithium battery terminal cover set as claimed in claim 1, wherein an insulation film is used to cover said terminal and said sealing plate, to fix said terminal onto said sealing plate.

6. The high-temperature-proof lithium battery terminal cover set as claimed in claim 1, wherein said sealing plate is fixed onto said housing through laser welding or ultrasonic welding.

7. The high-temperature-proof lithium battery terminal cover set as claimed in claim 1, wherein said two conductive plates are made of metal.
